(19) United States
(12) Patent Application Publication
(10) Pub. No.: US 2020/0003652 A1
(43) Pub. Date: Jan. 2, 2020

(54) SPATIO-TEMPORAL ANALYTICS FOR BURST DETECTION AND LOCATION IN WATER DISTRIBUTION

(71) Applicant: Arizona Board of Regents on Behalf of the University of Arizona, Tucson, AZ (US)

(72) Inventors: Kevin E. Lansey, Tucson, AZ (US); Jian Liu, Tucson, AZ (US)

(21) Appl. No.: 16/459,467

(22) Filed: Jul. 1, 2019

Related U.S. Application Data
(60) Provisional application No. 62/691,996, filed on Jun. 29, 2018.

(51) Int. Cl. G01M 3/28

(52) U.S. Cl. CPC G01M 3/2815

(57) ABSTRACT

A method is presented for detecting an anomalous event occurring in a water distribution system (WDS) equipped with a SCADA system and an AMI system. In accordance with the method, periodic hydraulic measurements are received from at least one hydraulic meter located at each of a selected number of end user premises in the WDS. The hydraulic meter includes a pressure meter. Based at least in part on the hydraulic measurements and a hydraulic model of the WDS, an anomalous event is determined when it occurs in the WDS.

### BACKGROUND

Water distribution systems (WDSs) capable of supplying a desired quantity of potable water are a key infrastructure for a modern sustainable city. As illustrated in FIG. 1, a typical WDS is composed of reservoir(s), storage tank(s), pump(s) and pipes. WDS service quality often degrades as a result of background leakage and pipe bursts. According to the American Water Works Association (AWWA), pipe bursts are occurring with higher frequencies, especially in the areas with aging WDSs that are not given adequate maintenance.

Water loss in water distribution systems (WDSs) is a global challenge. Bursts are a special case of short-term, high-flow water loss that can be a significant component of a system's water balance (IWA/AWWA¹). An extreme example is the pipe burst that occurred near the University of California Los Angeles (UCLA) where 10 million gallons of water escaped the pipe. However, the 30-foot fountain of water did not occur instantaneously; rather the size of the pipe crack and flow rate increased over time. As a hidden underground infrastructure this progression was not visible and the failure was not detected until it had catastrophic impacts, including $13 M of damages to the UCLA campus and 600 vehicles.

An estimated 240,000 pipe breaks occur annually in the US. Bursts occur at a rate of 0.25 failures per mile of pipe per year As reference, the City of Scottsdale, Ariz., which serves 250,000 people through 2,000 miles of pipe, would expect about 1.37 breaks per day. One assessment of the direct utility costs of breaks are upwards of $3B per year and other costs are likely at least as large. The costs of water loss, ancillary damages and the social costs of traffic and water service disruption are difficult to quantity. In addition to significant water losses, these flows embody the cost of treatment and pumping. Rapid bursts can cause abrupt pressure drops that may lead to contamination intrusion through cracks in pipes or connection backflows (flow reversals from customers to the distribution pipe) that degrade water quality and potentially threaten customers' health. Thus, it is imperative to minimize the time to detect and locate bursts. Early detection of the UCLA burst and smaller, more prevalent events will reduce overall cost as extensive breaks take longer to repair and cause more roadway and flooding damages.

Adoption of pipe burst detection technologies is inhibited by the lack of data acquisition systems to collect useful information and numerical tools that can analyze field information to assess that a burst is occurring and accurately identify the location of the failure. Utilities are generally conservative and pragmatic entities and will not invest in so-called supervisory control and data acquisition (SCADA) systems without a recognized return. Industry, on the other hand, has not invested in developing burst detection tools without an available market.

It is important to note the distinction between a pipe burst and water system leakage. Leaks are small flows caused by poor pipe manufacturing, corrosion, or occur at pipe connections. They occur throughout distribution systems and account for a large portion of the water loss as, although small, they flow continuously. Leaks are extremely difficult to detect without pipe-by-pipe studies. Bursts begin as leaks. As the size of a pipe crack or an opening at a joint gradually increases, water eventually reaches the ground surface or, due to the burst flow, reduces pressures to the point that customers complain. Except for some large bursts reported by customers, many bursts will remain unrecognized for some time if they occur at inaccessible locations, do not reach the ground surface, or occur during the night.

Predicting failure or conditions conducive to causing pipe failures is not possible, in part because pipe bursts are caused by a variety of factors, such as internal/external pipe corrosion, mechanical damage due to excavation, and poor workmanship during installation. Thus, automated approaches to monitoring WDS are necessary to insure early pipe burst detection and the location at which they occur.

Although conservative by nature, some utilities are beginning to expand their use of sensors in WDSs, but not for the purpose of burst detection. Progressive water companies are now collecting individual water user meter data electronically through automatic meter reading (AMR) and advanced metering infrastructure (AMI) systems. AMR records and reports water usage once during a billing cycle, normally through the sensor communicating with a computer on a truck that is driven by the meter. AMR is becoming relatively common in larger utilities due to the cost savings arising from the elimination of meter reader visits to each meter, but it provides no useful information to detect bursts in real-time. AMI, on the other hand, collects data on much shorter intervals and automatically relays that data to a central location. AMI is more costly but detects short-term household use that is valuable in warning customers of excessive use on their premises. AMI also allows a system-wide mass balance to be completed. However, for reasonable size systems or subsystems, many bursts are not sufficiently large to provide a signal that is not masked by variations in normal demands. AMI systems are thus often economically difficult to justify due to battery life expectancy and replacement costs that encourages less frequent data collection.

WDS supervisory control and data acquisition (SCADA) systems are normally relatively sparse and monitor tank water levels, pump flow rates and heads and flows from major sources. Like AMI water balances, these data are insufficient for burst detection. Linking traditional SCADA and AMI may provide some clues on water leakages and, at best, may detect, but not locate, large bursts. Atypically, enhanced SCADA systems measure pressure and pipe flow meters at distributed locations. These meters are often expensive to install due to the need for an energy source and a data transmission system and are generally not located with burst detection in mind. Previous burst detection research has been based on enhanced SCADA data availability and the resulting tools consider field measurements independently. This inhibits the likelihood of identifying that a burst is ongoing (identification effectiveness) and the rapidity of detection (efficiency) while increasing false alarm likelihood. Independent measurements may supply some limited information on the failure location.

### SUMMARY

Identifying that a burst has initiated and determining its location are issues that have not been satisfactorily addressed. One aspect of the present disclosure is to provide a new generation of WDS monitoring systems with a new interdisciplinary hydraulic informatics paradigm that integrates: (i) hydraulics-based, data-driven spatio-temporal (ST) modeling of the information from WDS monitoring systems; (ii) real-time detection and location of WDS bursts; (iii) optimal synthesis of monitoring system spatial layout and temporal sampling frequency; (iii) field validation with water utility partners. The benefits of such WDSs will be exposed in water systems that have lower water losses and improved customer satisfaction.

In one particular aspect of the present disclosure, two enhancements to conventional burst detection/location schemes are provided. The first extends the capabilities of current AMI/SCADA systems. Conventional AMI systems only monitor flow at the household level. However, as AMI systems already have an in-place data acquisition system, pressure meters can be provided to supplement household water meter flow data at a range of strategic locations. The additional cost for the meters and battery replacement will small relative to the AMI system. Smart data collection algorithms may be employed to efficiently use the systems to maintain battery life and to adjust pressures to account for energy losses between the distribution pipe and the meter during water use periods. By ‘piggy-backing’ pressure meters with existing data transmission and battery systems at easy to access and secure water meter locations, the additional measurements obtained in this way, perhaps further supplemented with pipe flow measurements, can provide a wealth of distributed information.

The second enhancement to traditional burst detection/location schemes provided in accordance with some embodiments of the present disclosure involves linking advanced data analytics with hydraulic engineering domain knowledge in a hydraulic informatics paradigm to provide algorithms that can assimilate that data for multiple locations simultaneously. The result is a system that can more accurately detect WDS anomalies and precisely determine the locations of anomaly-causing bursts.

### BRIEF DESCRIPTION OF THE DRAWINGS

FIG. 1 shows an illustrative water distribution system (WDS), which includes of reservoir(s), storage tank(s), pump(s) and pipes.

FIG. 2 shows a free-knot spline function that may be used to determine how to model hydraulic measurement data.

FIGS. 3A and 3B shos hydraulic measurements for a single sensor (a hydraulic meter) in normal operation (FIG. 3A) and when a burst occurs (3B).

FIG. 4 schematically shows the layout of the WDS for the city of Austin, Tex. network, which has three sensor groups (SGs) I, II and III.

### DETAILED DESCRIPTION

As explained in more detail below, in one aspect of the present disclosure, an AMI system that is used to supply information to a SCADA system for a WDS is supplemented with pressure meters that are located at selected end user locations. In this way the SCADA system receives from those locations both flow measurements obtained by existing flow meters and pressure measurements obtained by the pressure gages. This data can be used to address two long-standing problems that arise in WDSs. The first is to detect an anomaly such as a pipe burst when it occurs. The second is to identify the location of the anomaly with relatively high precision.

The data that is obtained through the AMI system can be used in different ways to address the aforementioned problems. One technique uses a hydraulic model of the WDS that can be used to calculate expected pressures in the system. Hydraulic models are available which take as input parameters the WDS architecture (e.g., the physical geometry of the pipes and their interconnections, the location and capacity of the pumps and tanks, etc.), the roughness of the pipes and possibly other system values, some of which are dynamic (e.g., water demand) and not necessarily well known. From these input parameters the hydraulic model can output the pressure at various points in the system. The calculated pressure can be compared to the measured pressure values obtained from the pressure meters to assess the accuracy of the hydraulic models. Model parameter estimates (primarily pipe roughness) will be improved as more data is collected.

Once the accuracy of the hydraulic model has been validated, it can be used to calculate the expected pressures in the system, which can be compared to the measured pressures. In this way the hydraulic model can be used to detect anomalies in the system when they occur or shortly thereafter. Potentially more accurate techniques are described below in which the hydraulic model is used in conjunction with machine-learning techniques.

Direct comparisons provide information by examining standard statistical measures of difference. More holistic views can be taken using machine learning and artificial intelligence methods that consider the hydraulic energy surfaces as images over time. A second technique that can be used to address the aforementioned problems involve machine-learning techniques that can analyze large datasets such as the hydraulic measurements (e.g., pressure, pipe flow) obtained using an AMI system equipped with pressure meters at selected (many) end user locations. For instance, functional data analysis (FDA) techniques can be used to manage the large amount of data generated by the AMI system by embodying the data in the form of functions or other objects. One FDA technique uses spline functions to summarize the collected measurement data. A detailed example using spline functions to analyze the data will be presented below. Other FDA techniques that may be employed include, by way of example, neural networks, wavelets, Fast Fourier Transform (FFT) analysis, polynomial functions, convolutional neural networks (CNN) and recurrent neural networks (RNN) and so on.

The machine learning techniques can be used to predict expected pressure values at different locations and times in the systems. Significant deviations from these expected values can be treated as anomalies.

In another aspect of the present disclosure, the hydraulic model that is developed can be used to inform the machine-learning techniques. For instance, the hydraulic model can be used to help select the form of the various parameters used by the FDA techniques and to tune the values of those parameters. In this way the hydraulic model is combined with machine learning algorithms to select a specific functional model of the system. Examples of how this may be accomplished are presented below.

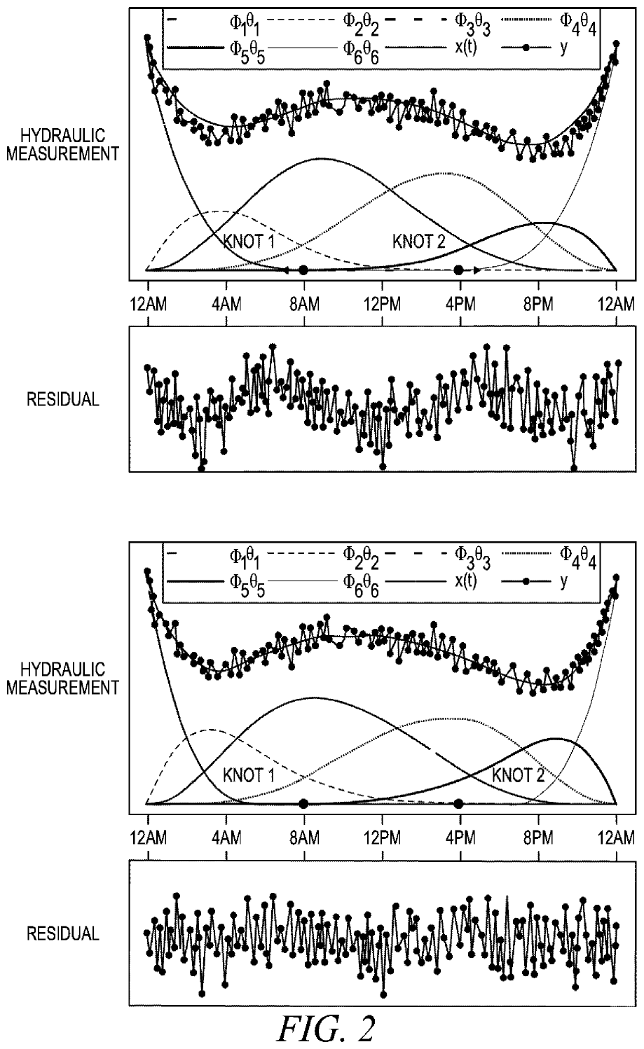

A detailed example of an FDA technique that employs spline functions will be presented below in connection with Sections 1-3. An overview of these sections now follows. First, in Section 1.1, spline functions are used to determine how to model the data (the hydraulic measurements) from an individual sensor (e.g., pressure meter, flow meter). For instance, FIG. 2 shows the use of individual spline functions to obtain an overall curve that goes through the data points. The various parameters of the spline functions are selected to minimize the residuals that are obtained for each data point. Next, in Section 1.2, the hydraulic model that has been developed is compared with the FDA model developed in Section 1.1 for a single sensor. From this comparison the parameters obtained for the spline functions in Section 1.1 can be tuned to further reduce the residuals. In addition, Section 1.2 also expands the FDA model from a single sensor to the entire system. Section 1.3 then assigns uncertainties or probability confidence values to the expected values obtained from the FDA model.

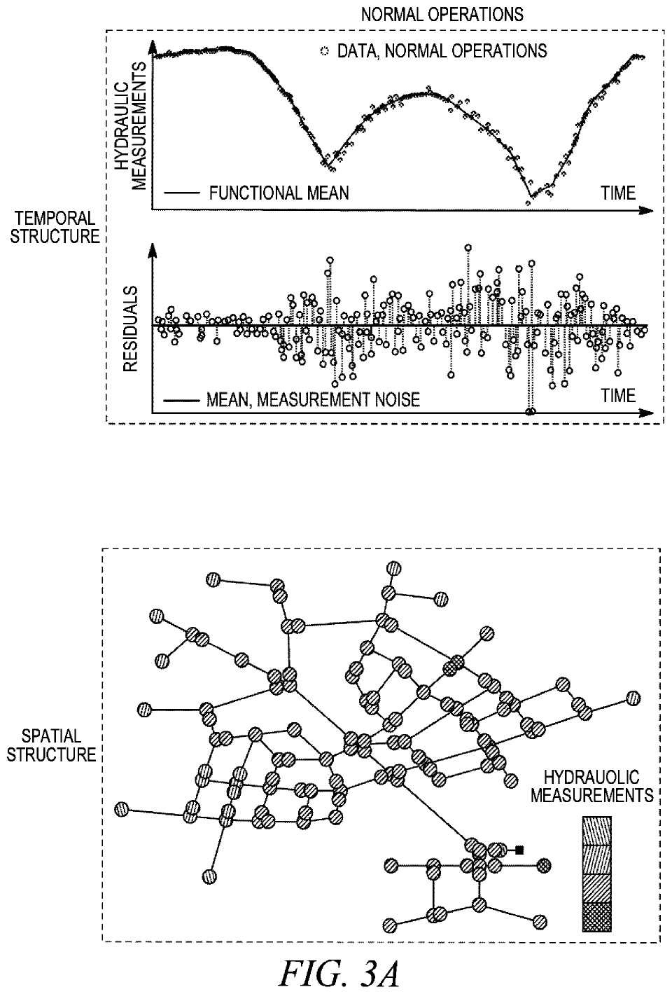

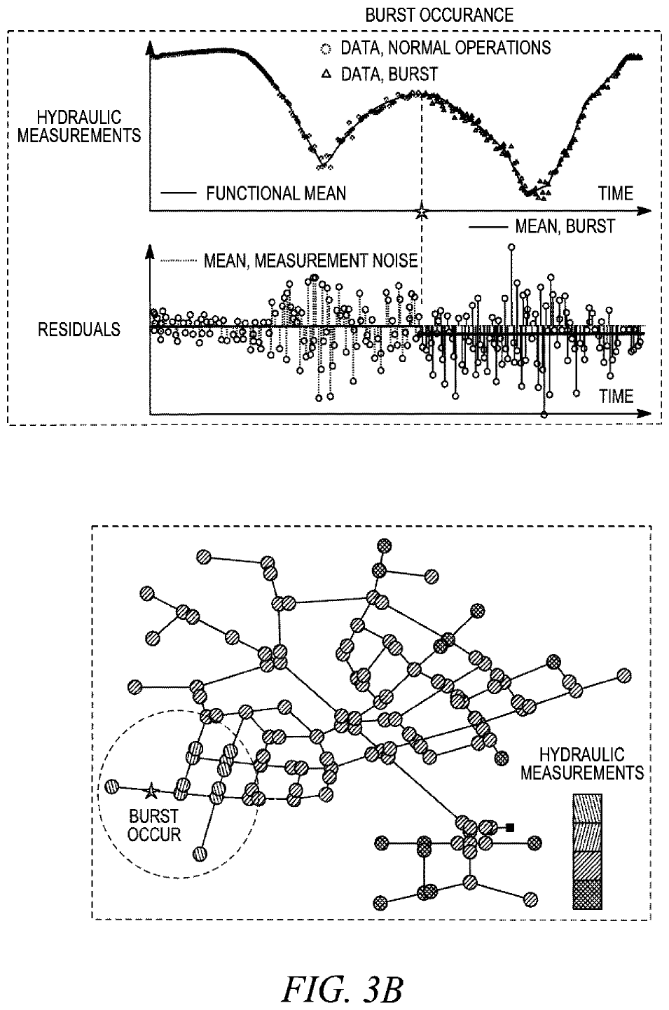

Section 2.1 develops rules for concluding that an anomalous event has occurred based on the expected values predicted by the FDA model and the measure values. For instance, FIGS. 3A and 3B shows hydraulic measurements for a single sensor in normal operation (FIG. 3A) and when a burst occurs (FIG. 3B). Below each set of measurements are the residuals, which are the difference between a measured value and the mean predicted value calculated from the FDA model for normal operation. When, as shown, a burst occurs, the mean residual value decreases. The pattern that arises in the mean residual values can be used for establishing the rules that are used to identify the occurrence of an anomalous event. For example, a rule could be established stating that an anomalous event has occurred when a certain number of measured values obtained over a period of time are all below the mean residual value (since normally a pattern of random fluctuations above and below the mean residual value would be expected). The rule may also take into account the magnitude of those measured value, since greater deviations from the expected values may make it more likely that an anomalous event has occurred. While the example in FIG. 3 is for a single sensor, a similar analysis may be performed for more (or all) of the sensors in the system, thereby increasing the confidence level in concluding that a burst or other anomalous event has occurred and facilitating identification of the burst location.

Section 2.2 then discusses how an anomalous event can be located by combining the results from section 2.1 with the hydraulic model. That is, given all the changes in pressure that are measured from the pressure meters, this section discusses how the most likely location of the burst or other anomalous event can be determined.

Section 3.1 develops a methodology for determining the number of pressure meters that are needed in the field and the end user locations at which they should be placed in a given WDS for the purpose of obtaining satisfactory results for the least cost. Likewise, Section 3.2 develops a methodology for determining how frequently pressure measurements should be made and if that sampling rate should be increased if an anomalous event is suspected. This analysis recognizes that many power meters will be supplied with power from batteries and that therefore conserving battery life (and possibly other resources such as the transmission bandwidth available for communicating the measured values to the SCADA system, particularly if wireless transmission is employed) is important. Accordingly, only a subset of all the available pressure meters may be in use at any given time, and this subset can be increased when a potentially anomalous event occurs. The extended AMI-SCADA system described herein significantly enhances spatial and temporal resolutions of SCADA data. We recognize that pressures at the water meters at end user premises will be affected by the flow to the premises. With the concurrent measurement of flow at the meter, it is possible to correct the measured pressure to estimate the pressure in the distribution system pipe. The resulting flow-corrected continuous hydraulic measurements at a set of nodes in the WDS through time is analogous to a video, such as a high-resolution spatio-temporal (ST)-data stream is essentially a set of observations sampled on discretized high-density grids over spatial and temporal continuum. Rich information about WDS status is contained in the ST data stream, providing unprecedented opportunities to enhance burst detection and location capabilities.

The convolution of spatial and temporal data stream results in a high-dimension ST-structure, whose complexity is fundamentally beyond the capabilities of the aforementioned conventional methods. This is because: (i) the engineering-driven methods depend on accurate hydraulic knowledge on WDS and its elements, whereas data-driven methods depend on abundant samples. The ST-structure of the extended AMI-SCADA data makes those methods no longer useful. (ii) Existing burst methods focus on either temporal dynamics or spatial correlations. Without simultaneous consideration of ST-structure, these methods will not be effective; and (iii) Existing methods detect bursts by comparing individual observations with their normal counterparts. Considering the high resolution of the ST-data stream, this strategy will not be efficient. In summary, a new paradigm is needed to fully take advantage of the available new data.

To that end, the techniques described herein employ a new hydraulic informatics paradigm, that integrates hydraulic engineering domain knowledge with the advance data analytics, to detect and locate bursts in WDS in a more effective and efficient way. The proposed methodology differs from the conventional methods in that, rather than detect changes from individual observations, it identifies the shifts of the ST-structure. Once a burst is identified as occurring, the WDS hydraulic state is exploited to determine the burst location. Table 1 summarizes some important aspects of various embodiments of this approach.

TABLE 1
Summary of Aspects of Various Embodiments

| | | Present Disclosure | |
|---|---|---|---|
| | | Advancements in | |
| | Conventional Data | Hydraulic | Advancements in |
| Problem | Driven Methods | Informatics | Data Analytics |
| ST-Structure | Black-box AI | New hydraulics-based | New hydraulic- |
| Modeling Detection & | State-space | data -driven spatio- | enhanced basis |
| Location | Kalman-filter | temporal model | formulation |
| Monitoring System | SPC/FIS/BIS | New burst detection | New offline estimation |
| Synthesis | Sensitivity Matrix | and location through | algorithm |
| | | spatio-temporal | New functional |
| | | decomposition | decomposition |
| | | New concepts: score | formulation |
| | | and criticality | New efficient online |
| | | New spatial sensor | functional smoothing |
| | | layout design | New system-level |
| | | New temporal | sensor evaluation |
| | | sampling planning | metrics |
| | | | New adaptive |
| | | | algorithm for optimal |
| | | | sampling |

Section 1—Unified ST-Structure Characterization

To detect potential bursts, it is important to characterize the nominal ST-structure of WDSs under normal operations without bursts. Any significant deviation from it will be classified as anomalies, e.g., bursts. The objective of this task is to develop a modeling methodology to learn such normal ST-structure from enhanced AMI-SCADA data streams.

As noted, the conventional fundamental hydraulic models may be inaccurate, due to uncertainty in field conditions. Data-driven methods modeling temporal dynamics alone provide either a black-box model with limited and predetermined time-lag (ANNs) or a model that is very sensitive to the temporal sequence of the observations (polynomial functions). Data-driven models of spatial correlations among sensors provide limited knowledge for burst detection.

Since the ST data streams from AMI-SCADA are collected from discretized grids of spatial (WDS nodes) and temporal (time stamps) continuum, they can be treated as a realization of underlying random hydraulic functions over time. Thus, the team will adopt a Functional Data Analysis (FDA) method to characterize both spatial and temporal characteristics of the ST-structure under normal conditions.

Section 1.1—Node-level Temporal Modeling

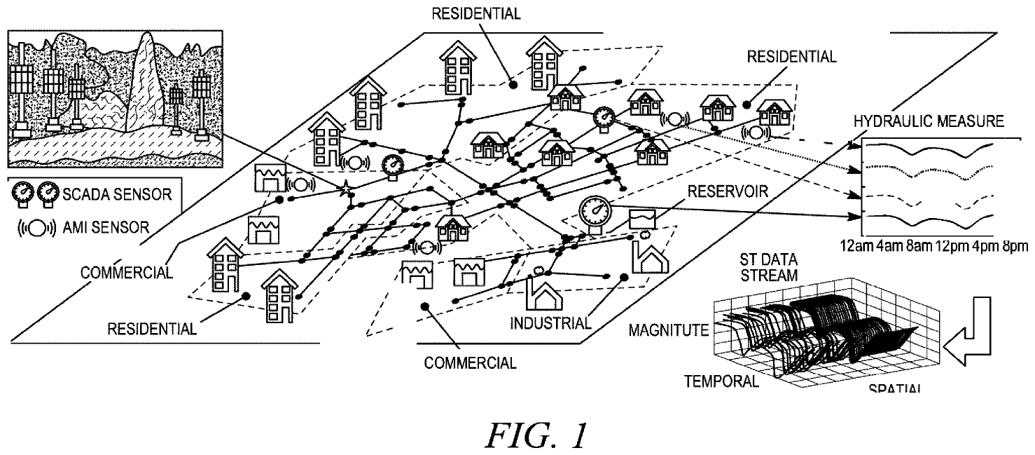

In this description, pressure measurements collected from the enhanced AMI-SCADA are defined as a type of “hydraulic measurement”. If available, pipe flow measurements will also be included in this set. That is, hydraulic measurements may include pressure measurements, water flow measurements and/or other measurements. For simplicity, we first model a one-dimensional hydraulic measurement continuously collected from a single node at discretized time points. Let yi denote the logged data from sensor i, where yᵢ=[yᵢ₁, yᵢ₂, . . . yᵢₙ]^{T}, n is the number of time stamps within a monitoring cycle, i=1, . . . , p, and p is the total number of nodes with sensors. Here, we choose one day as a monitoring cycle, as hydraulic measurements, such as pressure, are driven by customer water consumption with daily dynamic patterns (FIG. 1). It is assumed that the dynamics of the hydraulic measurement follows a certain unknown random function that is theoretically continuous and differentiable along time. Thus the daily hydraulic measurements from sensor i can be represented as:

$${γ}_{i} = {μ}_{T} + {ɛ}_{i} = {Φ}_{T} {θ}_{{i}_{{ɛ}_{i}}} , \qquad ( 1 )$$

where μ_{T} is an unknown random function of the temporal dynamics and can be further expanded with temporal smooth basis matrix, Φ_{T}; εᵢ is the vector of measurement errors at each time stamp. Given the hydraulic measurements collected from normal operations without bursts, the temporal dynamics of a measurement location i can be learned by estimating the model coefficient θᵢ.

In conventional FDA, B-Spline basis Φ_{T} is assumed known for smoothing of individual curves, as the basis functions are differentiable everywhere in the pre-defined interval. Given the known basis Φ_{T}, θi is determined to achieve smooth fitting. In this disclosure, the objective of node-level temporal modeling is to not only fit a smooth curve with arbitrary basis, but also to understand the temporal dynamics. The basis Φ_{T} provides the functional building blocks of such understanding. Thus, it should be assumed unknown and be determined from the sampled data streams to discern features and avoid over smoothing. We assume that a sample of N data streams is available. The asymptotic properties of the analysis results from this sample will be derived for the statistical inferences in Section 2.

Determination of the basis matrix can be achieved in two steps: (i) the periodic variations and transient changes associated to exogenous information, e.g., season, weather forecast and event prediction will be incorporated to the basis matrix as initial splines with “free-knots” and (ii): free-knots parameters T_{T}, which define the locations of knots in the interval, will be incorporated in a loss function as:

$$\begin{matrix}argmin \\ {θ}_{i} , {Φ}_{T} , {T}_{T}\end{matrix} {\sum }_{j = 1}^{N} {‖ ∈ ij ‖}^{2} + {λ}_{T} {θ}_{i} {R}_{T} {θ}_{i} , subject to \text{:} {y}_{ij} = {Φ}_{T} ( {T}_{T} ) {θ}_{i} + {ɛ}_{ij} , \\ for j = 1 , … , N \qquad ( 2 )$$

where ∥⋅∥ is the L₂ norm operator and R_{T} is a roughness matrix that prevents excessively “wiggly” function, λ_{T} is a tuning factor; yᵢⱼ is the j^{th} instance of hydraulic measurement taken at sensor i.

In this system, hydraulic domain knowledge will be used to provide formulation for candidate free knot locations T_{T}. Given T_{T}, the loss function (2) is convex and can be solved, iteratively, using general convex optimization solvers, such as the Gauss-Newton algorithm. As the knots move to “better” locations, the residual sum of squares will be reduced (FIG. 2). With the accumulation of historical data, T_{T} will be continuously refined. However, the problem scale will be significantly increased. The team will develop more efficient algorithms according to the basis structure. Accelerated proximal gradient (APG) algorithm and least square regression methods have great potential in solving such large-scale, high-dimensional optimization problems. In addition, we will follow the general k-fold cross-validation procedure to tune parameter λ_{T} and control model smoothness. The most important output from Section 1.1 is the optimal temporal basis, \hat{Φ}_{T}*, for the temporal dynamic description, the estimated basis coefficients, \hat{θ}ᵢ, and the mean function \hat{μ}_{ι}=\hat{Φ}_{T}*\hat{θ}ᵢ

Section 1.2—Hydraulic-based Data-Driven ST Modeling

Spatial information may contain more information on the nature of the variation in WDSs flow and pressure. Some literature concluded that global anomaly in WDS, i.e., simultaneous increase of water usage in an entire WDS, may indicate a normal condition. Consideration of this spatial pattern makes it possible to exclude false alarms triggered by transient weather changes, as bursts will only cause increases in water use in limited certain areas. Thus, it is essential to understand the spatial correlations among nodes, jointly with their temporal dynamics.

Spatial correlations can be derived from fundamental hydraulic relationships; conservation of mass and energy. Conservation of mass, i.e., Σinεinflow pipe Qᵢₙ−Σoutεoutflow pipe Qₒᵤₜ=q_{node}, is written for each junction and states that the flows into (Qᵢₙ) and out (Qₒᵤₜ) of a junction node must equal the withdrawal at that location. Withdrawals (q_{node}) are not strictly made at junctions. Nodal demands account for extractions along pipes and are assigned to the nearest node. Conservation of energy may be written in multiple forms but the most common is energy across a link is equal to the energy gain (pump) or loss (pipe or valve).

For a pipe, Hᵢ−KᵢⱼQᵢⱼ^{r}=Hⱼ, i,j=1, . . . , r, (3) where the difference in total head between the upstream (Hᵢ) and downstream (Hⱼ) nodes is related to the flow in the pipe connecting the two nodes and the pipe's characteristics Kᵢⱼ, which is a function of the pipe's diameter, length and roughness. Note that H's can be considered as the hydraulic measurements, y's, in Model (1). The nodal pressure is embedded in the total head (H pressure/γ+z) where pressure, γ, and z are the nodal pressure, specific weight of water and known (measured) node elevation, respectively. Given a set of demands these equations form a set of r nonlinear equations with an equivalent number of unknowns. Numerous hydraulic models are available that solve these equations for the pipe flow rates and the total pressure heads, showing the spatial correlations among nodes.

One-dimensional node-level temporal modeling creates the foundation for modeling the ST data stream. In addition, an optimal temporal basis from solving (2), Φ_{T}*, will be treated as given for the temporal basis. In this subtask, we will extend the modeling method to learn the ST-structure of the AMI-SCADA data stream, which is defined as a matrix of Y of size n×p, where Y=[y₁, y₂, . . . yₚ], and p is the total number of sensors deployed. We further define ψ=vec(Y) as the vectorized matrix, i.e., a long np×1 vector representing the ST data stream. Similar to the node-level temporal model, we assume that the daily ST stream hydraulic measurement can be represented as: ψ=vec(Y)=μ+e=ΦΘ+e, (4) where e=vec(ε₁, . . . , εₚ) and Θ=vec(θ₁, . . . , θₚ). The smooth functional mean j, has a smooth ST—Structure, and can be further expanded using both spatial and temporal smooth bases. Define Φ_{S} and Φ_{T} as smooth spatial and temporal bases, respectively. The ST bases can be obtained from the tensor product, i.e., Φ=Φ_{T}*⊗Φ_{S}.

Similar to the node-level temporal modeling, the spatial basis matrix Φ_{S} are not assumed given. On the contrary, it provides the basic elements to model spatial characteristics of nodes distributed in WDS. Thus, Φ_{S} should be determined by the integration of both hydraulic engineering domain knowledge represented in the system model. The two-step “free-knots” splines will be applied again to achieve smoothness and basis selection simultaneously through minimizing a penalized loss function as;

$$\begin{matrix}argmin \\ Θ , {Φ}_{S} , {T}_{S}\end{matrix} {\sum }_{j = 1}^{N} {‖ {e}_{j} ‖}^{2} + λ {Θ}^{T} R Θ , \\ subject to \text{:} {ψ}_{j} = ( {Φ}_{j}^{*} ⊗ {Φ}_{S} ( {T}_{S} ) ) {Θ}_{i} + {e}_{j} , for j = 1 , … , N \qquad ( 5 )$$

where Ψ is the j^{th}, j=1, . . . , N, instance of the ST data streams, roughness matrix R is defined as R=R_{S}⊗(Φ_{T}*)^{T}Φ_{T}*+(Φ_{S}*)^{T}Φₛ⊗R_{T}+R_{S}⊗R_{T}, and Rₛ and R_{T} are the roughness matrix that control the functional smoothness in spatial and temporal dimension, respectively. Domain knowledge on inter-sensor spatial correlations will be utilized to define initial free knot locations in Ts and improve the algorithm efficiency. The aforementioned optimization algorithms are still useful here to solve (5). Due to the increased computational complexity, the team will also investigate on more efficient algorithms. One possible approach is to use the domain knowledge on the spatial correlation to exclude potential locations for the free knots. An important output from Section 1.2 is the optimal spatial basis, \hat{Φ}_{S}*. Together with \hat{Φ}_{T}* from Section 1.1, the ST bases \hat{Φ}=\hat{Φ}_{T}*⊗\hat{Φ}_{S}*, the functional coefficients, \hat{Θ}, and the mean function \hat{μ}=\hat{φ}\hat{Θ} can be obtained. As \hat{Φ} is trained from the historical ST data streams collected from the WDS, it preserves ST-structure features better than arbitrarily defined bases.

Section 1.3—Uncertainty Analyses

As the functional smoothing and basis function estimates are obtained from a random sample of ST data streams, uncertainty in the estimated mean function must be evaluated. Here, we will examine the mean average squared error between the observations and smoothing results. As the knot location selection is involved in the smoothing process, the conventional cross-validation of the estimator is more time consuming. Thus, we will adopt the generalized cross-validation criterion. Karhunen-Loeve decomposition (among several approaches that can be applied) will be used to derive the functional covariance and its components, based on which is symptotic distributions for \hat{Φ} and \hat{Θ} can be derived. These results will be used to find the confidence intervals of the mean function or to statistically test the hypotheses about the smoothing parameters.

Section 2—ST-Structure Based Burst Detection and Location

The hydraulic-based data-driven ST-structure model obtained from Section 1 provides the basis for burst detection. Basically, it defines the ST-Structure under normal operations without bursts.

To detect bursts with a single sensor, a goodness-of-fit approach or a dynamic screening approach can be applied to monitor the irregularity in a single hydraulic measurement stream, even with partially available observations. If multiple data streams are available, nonparametric regression can be combined with longitudinal models for anomaly detection without considering spatial correlations among streams. Numerous methods have been developed to monitor spatial structure assuming a stationary mean, e.g., nonparametric kernel regression, splines, wavelet and principal component analysis (PCA). These methods are not applicable to ST data stream with non-stationary mean. No existing method is directly applicable for burst detection from ST data stream.

In Section 2, we will develop a new ST decomposition method for real-time burst detection. The key notion is to incorporate ST-structure characterization with WDS domain knowledge. ST data stream under normal operations is typically represented with a random functional mean, μ, with some smooth ST-structures characterized by smooth ST bases Φ and its associated coefficients Θ. A burst, in contrast, is an abrupt change with a ST-structure that is significantly different from the smooth mean. This rationale is justified from the results of preliminary work, which is illustrated in FIG. 3 for normal operation and operation when a burst occurs. These statistical inferences will be used together with the hydraulic models to implement real-time burst detection and location in Section 2. A hydraulic model solver will use these statistical detection results to locate the bursts and infer their sizes.

Section 2.1—ST Decomposition Based Real-Time Burst Detection

In this subtask, we define any ST data stream as a burst-potential observation, ψ_{b}, defined in the same way as ψ in (4). While ψ has two components, the burst-potential ψ_{b} can be decomposed into three, a functional mean μ, burst b, and measurement noise e, i.e.,

Ψ_{b}=μ+b+e=ΦΘ+Φ_{b}Θ_{b}+e, (6)

The component b accounts for the burst impact on the ST data stream. Φ=\hat{Φ}_{T}*⊗\hat{Φ}_{S}* represents the normal operation ST-bases are obtained by solving (5) in Section 1.2; The burst ST-bases is obtained from the tensor product of the temporal and spatial bases, Φ_{b,T} and Φ_{b,S}, respectively or Φ_{b,T}⊗Φ_{b,S}. As a result, model (6) can be transformed to Ψ_{b}=\hat{Φ}_{T}*⊗\hat{Φ}_{S}*Θ+Φ_{b,T}⊗Φ_{b,S})Θ_{b}+e, where Θ and Θ_{b} are the ST coefficients corresponding to functional mean under normal operations and the burst, respectively. Θ and Θ_{b} can be estimated from solving a penalized regression model, as

$$\begin{matrix}argmin \\ Θ , {Θ}_{b}\end{matrix} {‖ e ‖}^{2} + λ {Θ}^{T} R Θ , \\ subject to \text{:} {ψ}_{b} = ( {Φ}_{T}^{*} ⊗ ( {Φ}_{S}^{*} ) Θ + {Θ}_{b , t} ⊗ {Θ}_{b , s} ) {Θ}_{b} + e \qquad ( 7 )$$

where |⋅|₁ is the L₁ norm of a vector. Compared to (5), the additional L₁ norm penalty encourages spars bursts, i.e., the number of bursts in a given WDS at a given time is small, compared to the number of nodes or pipes in a WDS. To ensure the smoothness of the fitted functional mean, the roughness matrix R is determined in the same way as in Section 1.2.

The definition of the spatial and temporal bases for the burst is based on the understanding of the ST-structure of the potential bursts. The spatial bases Φ_{b,S} reflect the spatial distribution of the affected sensors. When a burst occurs, a cluster of near-by sensors is affected to varying degrees. This spatial clustering structure can be well represented by a B-spline basis. When a large-scale event affects a large portion of the WDS, an identity basis is appropriate. Temporally, a burst may occur abruptly and gradually increase over time. Thus, an identity Φ_{b,T} is a reasonable starting point. In this research, we will combine the hydraulic system model (3) and data analytics expertise to better define spatial and temporal bases to achieve better results. The parameters λ and γ will be determined via general cross-validation.

For a given ST data stream from a fixed number of observations (say, the nodal pressures from all the sensors in one day), an APG algorithm can be adopted to efficiently solve (7)⁶⁷, and obtained the estimated \hat{Θ} and \hat{Θ}_{b}. Two hypotheses tests then can be examined to determine if a burst is occurring:

H_{μ,0}:Θ=ΘₒVS H_{μ,1}:Θ≠Θ₀; and H_{b,0}:Θ_{b}=0 vs H_{b,1}:Θ_{b}≠0; (8)

where Θ₀ is achieved from the uncertainty analysis in Section 1.3. The rejection of the first test indicates the shift of the ST-structure under normal operations, whereas the rejection of the second test detects the bursts. Likelihood ratio test statistics will be derived and multivariate T² control chart or CUSUM control chart will be built based on the test, control chart limits will be defined based on the asymptotic distributions obtained from Section 1.3 and the estimated average in-control run length (ARL), which represents the utility acceptable false alarm rate.

TABLE 2
Performance Comparison - Preliminary Results

| | Conventional M-CUSUM | | | Proposed ST-Structure T² | | |
|---|---|---|---|---|---|---|
| Performance | SG-I | SG-II | SG-III | SG-I | SG-II | SG-III |
| Sensitivity (%) | 100 | 100 | 100 | 98 | 96 | 100 |
| False Alarm | 39.37 | 38.53 | 36.82 | 0.347 | 0.346 | 0.347 |
| (%) | | | | | | |

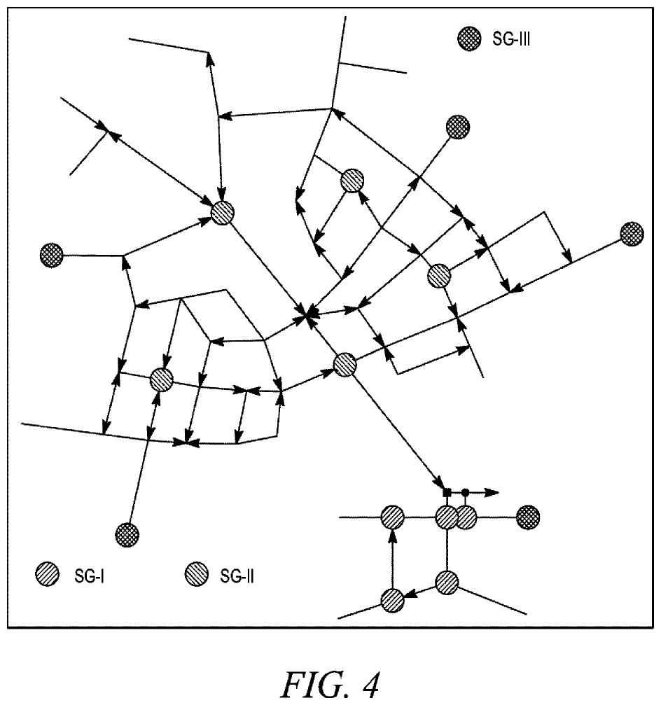

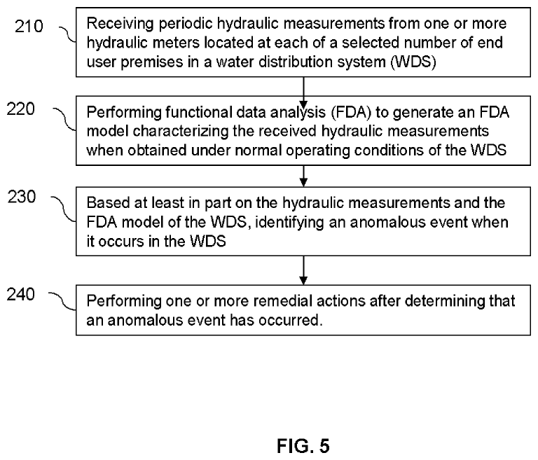

At any time t before the end of a monitoring cycle, Ψ_{b} is incomplete and thus, the model estimation and hypotheses testing cannot be accomplished, and the real-time burst detection is not achievable. One option is to use the data from the previous in-control cycle as a complement. A proof-of-concept case study was conducted on the City of Austin's network, with 1 nodes and 90 pipes. FIG. 4 shows the layout of the Austin network, which has three sensor groups (SGs) I, II and III. Nodal pressure data at a 5-min time interval are simulated with EPANET for both normal operations and 100 bursts. The measurements from three sensor groups each with five sensors (SG-I˜SG-III) are used for burst detection. Both conventional M-CUSUM control charts on pressure data, ψ_{b}, and the T² control charts on the proposed ST-Structure, Θ_{b}, are constructed. The performance comparison in Table 2 shows that both schemes had high detection performance (sensitivity). However, since the proposed method explicitly monitors the ST-Structure, it has a significantly lower false-alarm rate compared to M-CUSUM that neglects the non-stationary mean.

The drawback of such complementation method is the degraded effectiveness. This is because the complemented data from previous cycle are actually from an in-control process and thus cannot manifest the ST-structure of the out-of-control data.

For real-time burst detection, ψ_{b} can be treated as a temporally continuously growing ST data stream. Specifically, when a new sample are collected from all the sensors at t, the length of ψ_{b} will increase by the number of sensors, and the problem (7) is re-solved with the higher dimensional ψ_{b}(t). Consequently, over time, the dimension of ψ_{b}(t) grows to a size that cannot be solved by any optimization algorithm. Here, a recursive estimation procedure is proposed that uses

\hat{Θ}(t)=(\hat{θ}_{t-w}, . . . , \hat{θ}ₜ₋₁) and \hat{Θ}_{b}(t)=(\hat{θ}_{b,t-w}, . . . , \hat{θ}_{b,t-1}) estimated from the most recent data within a time-window of size w, and the current observation, which contains the hydraulic measurements collected from all the distributed sensors at the time t. The window will slide along time to achieve real-time burst detection. We will adopt the functional representation in a reproducing-kernel Hilbert Space and estimate θ(t) and θ_{b}(t) with a penalized partial least square problem. Burst occurrence can be examined using the same hypotheses tests in (8) except it will be based on \hat{θ}_{b}(t), where θb(t) and \hat{θ}_{b}(t) are the last spatial coefficient vector in Θ_{b} and \hat{Θ}_{b} at time t, respectively. T² and/or CUSUM control chart building procedure will then be conducted, with the control limits defined according to the predefined in-control ARL.

Section 2.2—Burst Location and Burst Size Estimation

An out-of-control signal indicates the detection of bursts in the WDS near one or more hydraulic sensors. This out-of-control signal on θ_{b}(t) reflects only the shift of ST-structure at time t. For the purpose of burst location, we will combine the detection results with the system model (3).

During a burst, a new unknown demand occurs that will reduce pressures across the network except in unusual cases with changing pump operations. The burst location problem is to identify the location and magnitude of that additional flow. With the enhanced AMI-SCADA system, each customer's flow meter can be polled to collect their current usages that are aggregated to calculate the nodal demands, q_{node}. With those values, the hydraulic equations can be solved to determine the pressure that would occur without the contribution of the burst. A least square minimization of the differences between measured and computed flows can be posed with q_{burst} as the decision variables. Solution of this nonlinear problem would be the best estimate of the burst location and discharge but it requires solving the hydraulic equations, likely in a computationally expensive stochastic search technique.

To simplify this problem, we can take advantage of the system response linearity. The PI's previous work showed that, for a wide range of conditions, those gradients are constant. That is, a change in nodal demand (q_{burst_i}) at a node i will have a constant change in pressure head at another location j, i.e.,

∂Hⱼ∂q_{burst_i}=constant, over a wide range of q_{burst_i}. These gradients are computed off-line and retained.

Given the observed heads at time t, (H_{obs}), equivalently, ψ/b, and an estimate of H from solving the hydraulic model (H_{model}) using only the measured nodal withdrawals, the optimization problem is to minimize the sum of absolute deviations or ΣⱼΣᵢH_{obs,j}−H_{modeled,j}(q_{node})−(∂Hⱼ ∂q_{burst_i})q_{burst_i} for q_{burst} with

each q_{burst_i}≥0. This problem can be reformulated as a linear programming problem to solve quickly.

The total head surface can be relatively flat except for large breaks. Thus, the solution to these problems are likely not unique and demands at several locations near the burst will provide objective functions that are similar. This is especially true for densely gridded networks. As additional measurements are collected, new demand conditions can be appended to fine-tune the burst location and reduce the possible domain where the burst might have occurred. A second potential strategy could be to install many meters and progressively collect pressure data from a narrower set of meters to telescope in toward the true location. A third strategy is to incorporate the data analytics results from Section 2.1.

Suppose the control chart triggers an out-of-control signal at time τ, the burst impacts can be estimated as \hat{b}(τ)=Φ_{b,S}\hat{θ}_{b,S}(τ), where \hat{b}(τ)=\hat{b}_{1,τ}, . . . , \hat{b}_{p,τ}^{T}. Through statistical hypothesis testing, only the b_{j,τ}'s significantly deviating from 0 indicate that the corresponding nodes j's and their associated nodes are affected by the burst. This \hat{b}(τ) can be used to restrain feasible solution space and expedite the algorithm.

Section 2.3—Performance Evaluation

The performance of the proposed burst detection and location methods will be evaluated with respect to the effectiveness and efficiency. Effectiveness can be evaluated by the sensitivity, i.e., TP/(TP+FN), and specificity, i.e., TN/(FP+TN), where TP, FN, TN and FP denote true positive, false negative, true negative and false positive, respectively. Efficiency will be evaluated by the actual out-of-control ARL for the control charts developed in Section 2.1 for field simulated bursts and/or computer simulation. As control charts are designed with control limits that reflect theoretical sensitivity, specificity and ARL, the actual sensitivity, specificity and ARL will be compared with their theoretical counterparts. Significant performance discrepancies will indicate inadequate model fitting in Section 1 or inappropriate control chart or test design in Section 2. If they occur, the team will review critical assumptions for modeling, control charting and test design and re-conduct uncertainty analysis in Section 1.3.

The above metrics will be calculated for the entire mentoring system with p sensors to give the monitoring system an overall performance evaluation. The performance of individual sensors in terms of their contribution to the overall burst detection and location power must also be evaluated. Graphical sensitivity tables are available for this analysis. The sensitivity of a particular sensor to a burst at a given burst location defines the importance of the sensor, but not its criticality as a monitoring system component. We propose a scoring mechanism in addition to the sensitivity table. Consider a monitoring system with p sensors deployed for a WDS with M potential burst locations. When the control charts developed in Section 2.1 detect a burst at location m at time τ, β*(τ, m) will be generated a burst is detected, the score assigned to sensor i is defined as S_{i,τ,m}=δ(β_{j,τ,m}=1)/|β* (τ, m)|₁, (9) where |⋅|1 is the L1 norm giving the total number of sensors that detect the burst; δ (ω)=1 if ω is true, or δ(ω)=0, otherwise. Physically, this score means that if totally q, q=|β*(τ, m)|₁, sensors successfully detect a burst, each one shares a credit of 1/q. A score matrix S, S=(S_{m,i}), and S_{m,i}=Σ_{τ}(Si, τ, m), (10) will record the accumulated score of each sensor I to a burst location m at different times, i.e., S_{m,i}.

The score rationale is that, while an individual sensor may be sensitive to the bursts in a given region, if it always detects the bursts together with other sensors, it is not critical to locating bursts and should receive a low total score to account for this redundancy. On the other hand, if a sensor uniquely detects a burst from some location, it will receive high, accumulated score denoting its criticality to that location. In this a system, a score matrix S will be created based on computer simulation and field simulated tests.

Section 3—WDS Monitoring System Synthesis

An optimal WDS monitoring system can be synthesized through the score matrix S where optimal maximizes efficiency and effectiveness by adjusting monitoring system spatially and temporally.

State-of-the-Art: a target oriented monitoring system sought to define the locations and sampling time intervals of the hydraulic measurements. Sensitivity matrices have been widely used to determine the monitoring system layouts. As noted, sensitivity is not a comprehensive metric. Further, the sensitivity-based approaches do not access sampling time intervals, which need to be optimally determined to save the sensor batteries. Although method on selecting a polling time step has been investigated, it is only applicable to offline decision-making, not for real-time online and adaptive sampling planning. In this task, we propose a monitoring system synthesis methodology that addresses meter layout design and sampling planning.

Section 3.1—Monitoring System Layout Syntheses

We take advantage of the score matrix and computer simulation capabilities to design the monitoring system layout, i.e., where to deploy the sensors to monitor potential bursts in WDS. To achieve this goal, we first define a series of new metrics. The score matrix S in (10) is the sum of components in a row m, Eₘ=Σᵢ₌₁^{p}S_{m,j}, is the total number of location-m bursts detected. Thus, criticality of sensor i to location m is defined as C_{m,i}=S_{m,i}/Eₘ, or the relative weight of sensor i compared to its peers.

For the layout design, we assume unlimited resources and deploy p sensors to ensure 100% sensitivity. Redundancy will then be re uced by removing a subset of sensors to save cost, without sacrificing sensitivity, i.e.,

_{I}^{arg max}Σ_{iεI} [symbol] ᵢ−ρᵢC_{m,i}, subject to: ϑₘ=(Eₘ−ΣiεIS_{m,i})/Aₘ>ξ, for m=1, . . . ,M. (11)

where Cᵢ is the gain from removing sensor i, ρᵢc_{m,i} with the penalty coefficient ρᵢ is the corresponding loss; Aₘ is the total number of bursts at location m. It is not difficult to show that ϑₘ defines the lower bound of the system sensitivity to location-m bursts using the definitions of S_{m,i} and Eₘ. Solving this maximization problem will give an optimal set of sensors I* whose removal will lead to the maximum gain with the monitoring system sensitivity to the bursts in all locations preserved (>ξ).

Considering the number of locations and the number of potential options for sensor removal, this optimization problem is very complex and the potential solution space may be extremely large. Thus, heuristic search algorithms, such as genetic algorithms and particle swarm optimization will be considered. Domain expertise can be used to reduce the solution space. The model coefficients, e.g., ρᵢ's, may also contain more information on the cost of outage time while the damaged pipe is repaired.

Section 3.2—Adaptive Autonomous Sampling Planning

As the AMI sensors transmit data through the wireless network, it will be more cost effectiveness for these sensors to work intermittently with low frequency and save battery life and network bandwidth. Another benefit of having a subset of sensors providing data is that the computational complexity the recursive optimization problem (7) will be reduced since only a part of the ST data stream is considered at any time. Thus, although the sampling frequency is reduced, the overall sampling rate can be increased.

An algorithm will be developed to autonomously make decisions on the set of sensors that should be active at a given time. Given the spatial monitoring system layout design from Section 3.1, assume there are p sensors distributed in WDS. At time t, a subset of d, d<M, sensors are active, forming an active set denoted as Iₐ(t). The adaptive sensing planning is to determine an active set for t+1, Iₐ(t+1), to maximize the probability of detecting the potential bursts, i.e., finding an optimal Iₐ(t+1) by using an adaptive Kernelized Maximum Minimum-distance (KMM) that uses Computer Experimental Design approach for the random exploration of the solution space. Specifically,

Iₐ*(t+1)=_{I}_{ₐ}^{arg max ℏ}(Iₐ)δ(Iₐ), where ℏ(Iₐ)=Σₖ₌₁^{K}p(I_{a,k})G(I_{a,k},Iₐ(t))+v, (12)

Iₐ can be chosen from total of K candidate sensor subsets {I_{a,k}|k=1, . . . , K}, and K can be as large as number of combinations of choosing d out of p; p(I_{a,k}) is the probability to detect the burst with the sensor subset I_{a,k}; the Gaussian kernel centered at the current sensor subset Iₐ(t) that will return a high value for similar I_{a,k}; V is the weighting coefficient adjusting the probability that none of the possible sensor subset gives positive probability of detection. Thus, n(Iₐ) is essentially the estimated probability of successfully detecting a burst. Maximizing n(Iₐ) will encourage a more focused sensing around Iₐ(t), since less change will achieve a higher Gaussian kernel and implies that the sensing polling will continue on the sensor that gives a higher burst detection probability. The regularization term [symbol] (Iₐ) will penalize switching among sensors that are highly correlated. Thus, this formulation will autonomously activate sensors that will give higher probability to detect bursts in the next time stamp. The calculation of p(I_{a,k}) will involve the computation of dimension-reduced ST data stream. The spatial correlation and online detection results be used to further reduce the solution space of I_{a,k}. The result will be a spatially optimally distributed monitoring system with autonomous and adaptive sensing capability.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the embodiments of the invention.

1. A method for detecting an anomalous event occurring in a water distribution system (WDS) equipped with a SCADA system and an AMI system, comprising:
receiving periodic hydraulic measurements from at least one hydraulic meter located at each of a selected number of end user premises in the WDS, the at least one hydraulic meter including a pressure meter; and
based at least in part on the hydraulic measurements and a hydraulic model of the WDS, determining when an anomalous event occurs in the WDS.

2. The method of claim 1, further comprising performing functional data analysis (FDA) to generate an FDA model characterizing the received hydraulic measurements when obtained under normal operating conditions of the WDS, wherein determining when an anomalous event occurs is also based at least in part on the FDA model.

3. The method of claim 2, wherein performing FDA to generate an FDA model includes selecting parameters for use in the FDA model based in part on the hydraulic model of the WDS.

4. The method of claim 2, wherein performing FDA to generate an FDA model includes tuning parameters used in the FDA model based in part on the hydraulic model of the WDS.

5. The method of claim 2, wherein the FDA employs spline functions to characterize the received hydraulic measurements.

6. The method of claim 2, wherein the FDA employs a technique to characterize the received hydraulic measurements selected from the group including wavelets, Fast Fourier Transform (FFT) analysis and polynomial functions.

7. The method of claim 2, wherein determining that an anomalous event has occurred includes generating predicted hydraulic values at selected locations in the WDS from the FDA model and comparing the predicted hydraulic values to measured hydraulic values.

8. The method of claim 1, wherein receiving the periodic hydraulic measurements includes receiving the periodic hydraulic measurements at the SCADA system from the AMI system.

9. The method of claim 1, further comprising determining a location at which the anomalous event has likely occurred based on the hydraulic model and the hydraulic measurements.

10. The method of claim 1, wherein the anomalous event is a pipe burst.

11. The method of claim 1 wherein the selected number of end user premises equipped with a pressure meter is a proper subset of all end user premises in the WDS.

12. The method of claim 1 wherein the hydraulic meter located at least some of the end user premises include a pressure meter and a flow meter such that the received hydraulic measurements include pressure and water flow measurements.

13. The method of claim 1 wherein determining when an anomalous event occurs in the WDS includes determining in real-time when an anomalous event occurs in the WDS.

14. The method of claim 2 further comprising determining, for each hydraulic measurement, a mean residual value that is defined as a difference between a value of a hydraulic measurement and a mean predicted value for the hydraulic measurement calculated from the FDA model.

15. The method of claim 14 further comprising identifying a pattern in a number of hydraulic meters that indicate an occurrence of a decrease in the mean residual value and determining that an anomalous event has occurred based at least in part on the pattern.

16. The method of claim 7 wherein determining when an anomalous event occurs in the WDS includes determining that a cluster of hydraulic meters within a defined spatial location provide hydraulic values that deviate from the predicted hydraulic values.
